(19) United States
(12) Patent Application Publication
(10) Pub. No.: US 2006/0249955 A1
(43) Pub. Date: Nov. 9, 2006

(54) Gravity energy transformer

(76) Inventor: Iacob Stanciu, Woodside, NY (US)

Correspondence Address: LITMAN LAW OFFICES, LTD, PO BOX 15035, CRYSTAL CITY STATION, ARLINGTON, VA, 22215, US

(21) Appl. No.: 11/478,766

(22) Filed: Jul. 3, 2006

Related U.S. Application Data
(63) Continuation-in-part of application No. 11/094,536, filed on Mar. 31, 2005.

(51) Int. Cl. F03G 7/08

(52) U.S. Cl. 290/1 R

(57) ABSTRACT

The gravity energy transformer includes a housing. First and second rotational shafts are mounted in the housing, each shaft having ends. First and third wheels are mounted proximate the ends of the first shaft on either side of a generator mounted on the first shaft, each wheel having an axis and halves on either side of the axis. Second and fourth wheels are mounted proximate the ends of the second shaft on either side of a generator mounted on the second shaft. A pair of weights are mounted on halves of the first and second wheels on the same side of their axes, and a pair of weights are mounted on halves of the third and fourth on the same side of their axes, the positioning of the weights on the first and second wheels counteracting the positioning of the weights on the third and fourth wheels.

### CROSS-REFERENCE TO RELATED APPLICATION

This application is a continuation-in-part of prior U.S. patent application Ser. No. 11/094,536 filed Mar. 31, 2005, which is hereby incorporated by reference in its entirety.

### BACKGROUND OF THE INVENTION

1. Field of the Invention

The present invention generally relates to power generating systems and, more particularly, to a gravity/energy transformer.

2. Description of the Related Art

Energy production is of major interest throughout the world due to great dependence on energy use. Fossil fuels provide most of the energy in use today. Coal, oil, and natural gas are all fossil fuels created millions of years before the decay of plants and animals. These fuels lie buried between layers of earth and rock. Fossil fuels are still being created today by underground heat and pressure. However, since they are being consumed much more rapidly than they are created, they are considered to be non-renewable. At the current rate of energy use throughout the world, it would appear that non-renewable energy sources will be used up sometime in the future. A number of renewable energy sources are also known. These renewable energy sources are much more environmentally friendly than fossil fuels when they are burned.

Solar energy is one example of a renewable energy source. The outer atmosphere of the earth intercepts about 1,500 quadrillion kilowatt-hours per year of energy generated by the sun. Because of reflection, scattering, and absorption by gases and aerosols in the atmosphere, only about forty-seven per cent of this energy, or about 700 quadrillion kilowatt-hours reaches the surface of the earth. The amount of incident energy per unit area and day depends on a number of factors including latitude, local climate, season of the year, inclination of the collecting surface in the direction of the sun, etc. Harnessing the light and sun of the sun is a clean, simple, and natural way to provide many needed forms of energy. It can be absorbed in solar collectors to provide hot water or space heating in households and commercial buildings. It can be concentrated by parabolic mirrors to provide heat at up to several thousands degrees Celsius. This heat can be used either for heating purposes or to generate electricity. Photovoltaic cells can be used to convert solar radiation directly into electricity.

Solar energy can also be converted to useful energy indirectly through other energy forms such as biomass, wind or hydropower. Carbon dioxide from the atmosphere and water from the earth are combined in the photosynthetic process to produce carbohydrates (sugars) that form the building blocks of biomass. The solar energy that drives photosynthesis is stored in the chemical bonds of the structural components of biomass. Biomass supplies about fourteen per cent of the primary energy consumption of the world.

Wind energy resources are less predictable than solar energy, but are normally available for more hours in a given day. Wind resources are influenced by the ground surface and obstacles and are much more site-specific than solar energy. Wind energy also follows seasonal patterns that provide the best performance in the winter months and the lowest performance in the summer months. This is just the opposite of solar energy. As such, small wind and solar systems work well together in hybrid systems. Wind turbines are moved by the wind and convert this kinetic energy directly into electricity by spinning a generator.

Hydropower occurs when falling water is captured to generate electricity. A turbine and generator convert the energy from the water to mechanical and then electrical energy. The turbines and generators are installed either in or adjacent to dams, or use pipelines to carry the pressured water below the dam or diversion structure to the powerhouse. Pumped storage hydro-electricity occurs when water in one reservoir at a higher altitude is released to a reservoir at a lower altitude to generate electricity. When the water is released, kinetic energy is created by the discharge through high-pressure shafts, which direct the water through turbines connected to generators/motors. The turbines power the generators to create electricity. After the generation is complete, water is pumped back to the upper reservoir for storage and readiness for the next cycle.

Another renewable energy source is ocean waves. Ocean wave devices capture the energy of waves and convert their energy to electricity. Wave energy devices include hydro-piezoelectric, oscillating water columns, wave run up and sea clams. Sea clams involve wave action forcing air between blades located on the perimeter of a circular barge structure. The air is then run through air turbines that rotate at a shaft connected to an electrical generator.

Tidal energy is a renewable energy source where the energy is extracted from the potential and kinetic energies of the earth-moon-sun system. Ocean tides result from this interaction, producing variations in ocean levels along the shores of all continents. As the water fluctuates twice daily through this range, it alternately fills and empties natural basins along the shoreline. Currents flowing in and out of these basins can be used to drive water turbines connected to generators to produce electricity.

Gravity is another renewable source of energy. Various techniques have been used to convert gravitational energy into electrical energy. For example, a reciprocating drive mechanism is known for lifting liquid from a lower reservoir to a higher reservoir with turbines between the higher and lower reservoirs that are turned by liquid falling down from the top reservoir through turbines to the lower reservoir.

German Patent No. 4,329,964, published Feb. 10, 1994, has balance rails but does not appear to disclose nor suggest the features and configuration of the present invention. Similarly, French Patent No. 2,717,864, published Sep. 29, 1995, appears to disclose moving arms for capturing kinetic energy, but does not appear to disclose nor suggest the features and configuration of the present invention. German Patent No. 19,910,957, published Sep. 14, 2000, has a configuration of a flywheel mounted on a metal tube by ball bearings, yet does not appear to disclose nor suggest the features and configuration of the present invention. Moreover, European Patent No. 1,201,924, published May 2, 2002, uses weight pressure with a cylinder and gravity weights, however does not appear to disclose nor suggest the features and configuration of the present invention.

However, current work being done on devices for converting gravitational energy to electrical energy are a fraction of work being done in other renewable energy sources.

Renewable energy sources will play an increasingly important role in the power generation mix future. Therefore, a need exists to provide a gravity/energy transformer to effectively contribute to the use of gravitational energy in providing electricity because the shape of our future will be largely determined by how we generate and apply technological innovation.

None of the above inventions and patents, taken either singly or in combination, is seen to describe the instant invention as claimed. Thus, a gravity energy transformer solving the aforementioned problems is desired.

### SUMMARY OF THE INVENTION

The present invention is a gravity/energy transformer. The gravity/energy transformer includes a housing. First and second rotational shafts are mounted in the housing, each shaft having ends. Generators are mounted on each rotational shaft. First and third wheels are mounted proximate the ends of the first shaft on either side of the generator mounted on the first shaft, each wheel having an axis and halves on either side of the axis. Second and fourth wheels are mounted proximate the ends of the second shaft on either side of the generator mounted on the second shaft. A pair of weights is mounted on halves of the first and second wheels and is positioned so that their respective weights are positioned on the same side of their axes. A pair of weights is mounted on halves of the third and fourth wheels so that their respective weights are positioned on the same side of their axes. The weights on halves of the first and second wheels are positioned opposite the weights on halves of the third and fourth wheels in order to rotationally counteract one another.

The gravity/energy transformer also includes a metal bar rotationally attached proximate a circumference of the first and second wheels on the half of the wheel opposite the half of the associated wheel where the weights are mounted, and a metal bar rotationally attached proximate a circumference of the third and fourth wheels on the half of the wheel opposite the half of the associated wheel where the weights are mounted.

These and other features of the present invention will become readily apparent upon further review of the following specification and drawings.

### BRIEF DESCRIPTION OF THE DRAWINGS

FIG. 1 is a perspective sectional view of a gravity/energy transformer according to the present invention.

FIG. 2 is a top cross-sectional view of the gravity/energy transformer shown in FIG. 1.

FIG. 3 is a side cross-sectional view of the gravity/energy transformer shown in FIG. 1.

FIG. 4 is a perspective sectional view of an alternative embodiment of the gravity/energy transformer according to the present invention.

FIG. 5 is a top cross-sectional view of the alternative embodiment of the gravity/energy transformer according to the present invention.

FIG. 6 is a side cross-sectional view of the alternative embodiment of the gravity/energy transformer according to the present invention.

Similar reference characters denote corresponding features consistently throughout the attached drawings.

### DETAILED DESCRIPTION OF THE PREFERRED EMBODIMENT

The present invention is a gravity/energy transformer. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

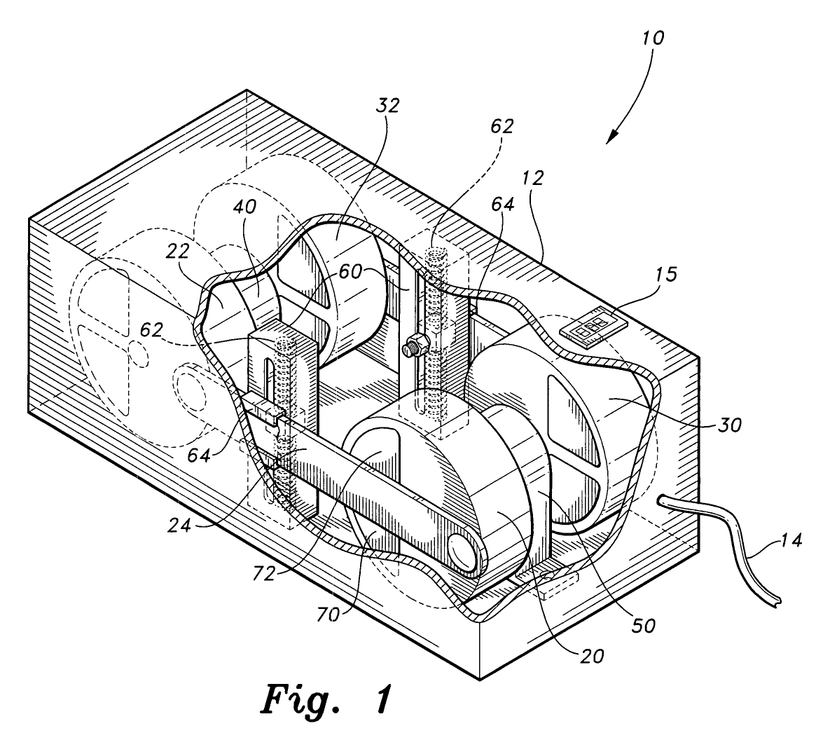

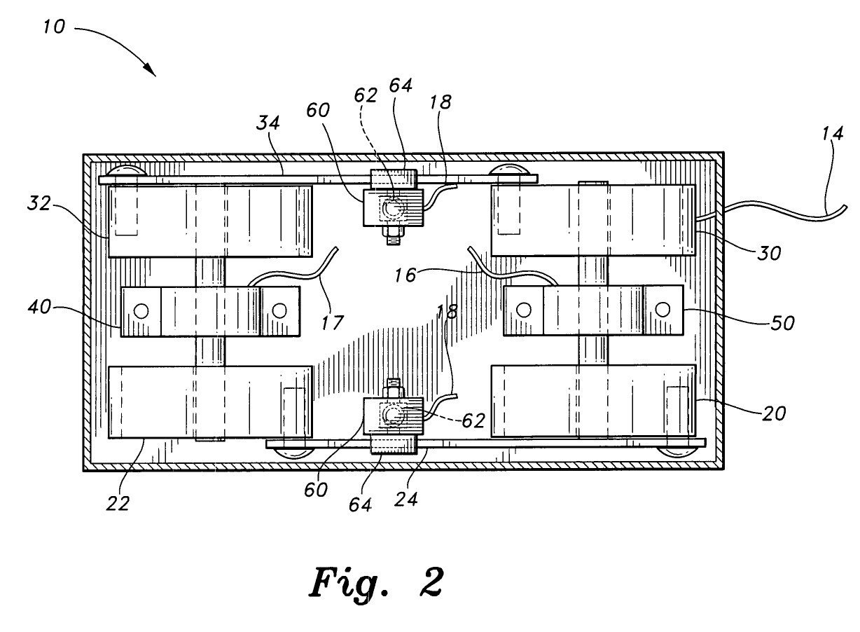

Referring to the drawings, FIGS. 1-3 show a gravity/energy transformer 10 according to the present invention. The gravity/energy transformer 10 includes a housing 12 with a power output cord 14 extending from a side of the housing 12. The housing 12 is preferably made of metal, such as iron, steel, aluminum, etc. The power output cord provides AC and/or DC electrical output power according to the desires of the user. A display 15 is provided on the housing 12 to provide an analog and/or digital indication of the amount of AC and/or DC electrical output power being developed by the gravity/energy transformer 10. Other interface elements can be provided on the housing, such as an on/off switch, emergency stop switch, external conventional starter and battery for initiating gravity/energy transformer operation, etc.

The display 15 can be any type of analog or digital display, such as a dial indicator, an LCD, an organic LCD display, an LED display, an OLED display, a thin film transistor display, or the like. Such a display can also be a touch sensitive screen (“touch screen”) to enable users to select reading options from the display 15 by touching the surface adjacent an indicated button icon or the like.

Components of the gravity/energy transformer 10 are mounted within the housing 12. The components include four rotational wheels 20, 22, 30 and 32. Wheels 20 and 30 are rotatably mounted on a shaft that passes through a generator 50 that is mounted to the housing 12. The wheels 22 and 32 are rotatably mounted on a shaft that passes through a generator 40 that is mounted to the housing 12. Each wheel 20, 22, 30 and 32 has a pair of weights mounted therein.

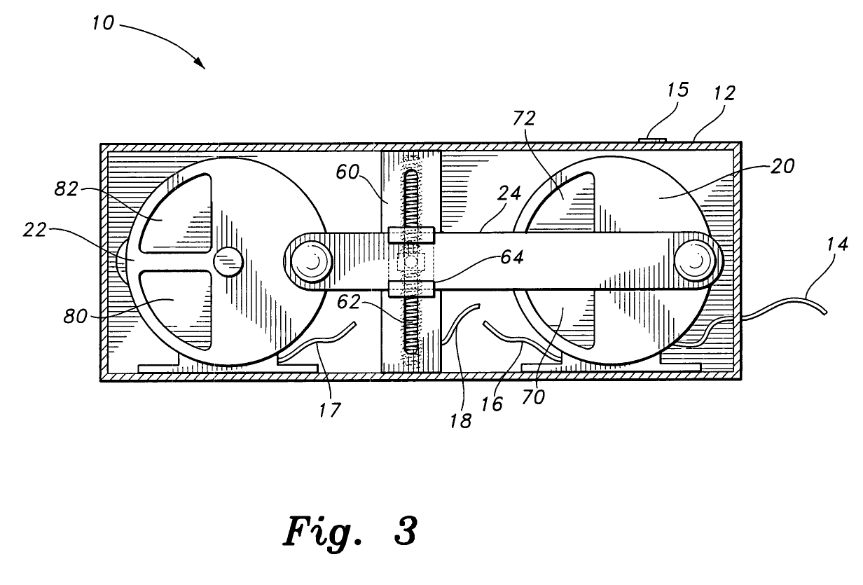

As shown in FIG. 3, the wheel 20 has a pair of weights 70 and 72 mounted therein, and the wheel 22 has a pair of weights 80 and 82 mounted therein. The size of the weights can be varied as desired. The weights 70 and 72 are positioned on one half of the wheel 20, and the weights 80 and 82 are positioned on one half of the wheel 22. When the wheels 20 and 22 are mounted to their respective shafts, the wheels 20 and 22 are positioned such that their respective weights 70 and 72 are positioned on the same side of their respective shafts. The corresponding wheels 30 and 32 on the opposite sides of the shafts each include similar pairs of weights.

However, when these wheels 30 and 32 are mounted on their respective shafts, they are positioned such that their respective pairs of weights are on opposite sides of their respective shafts than the positions of the weights of their corresponding opposing wheels 20 and 22. The weights of the mounted wheels 20 and 30, and 22 and 32, respectively, are positioned in this manner to rotationally counteract the weight of each other. Therefore, upon initiating rotation of one pair of wheels 20 and 30 on their rotational shaft, when the weights 70 and 72 of the wheel 20 are above the axis of the shaft, the potential energy of the weights 70 and 72 are at their greatest. The rotation the shaft occurs due to the gravity that causes the weights on the wheel 30 to fall below the axis of the shaft. This cycle repeats itself for a predetermined amount of time until friction causes the rotation of the wheels to stop.

A thin conductive metal bar 24 is rotationally attached proximate the circumference of each wheel 20 and 22 opposite the position of the weights 70, 72, 80, 82 of each respective wheel 20 and 22. In a similar manner a thin conductive metal bar 34 is rotationally attached proximate the circumference of each wheel 30 and 32 opposite the position of the weights of each respective wheel 30 and 32. As the two pairs of wheels 20 and 30 rotate on one shaft and the two pairs of wheels 22 and 32 rotate on the other shaft, the position of the bars 24 and 34 move so that when the weights of the wheels 20 and 30 are at their lowest position, their interconnecting metal bar 24 is at its highest position. At the same time, the two pairs of wheels 22 and 32 are rotating and their interconnecting metal bar 34 is at its highest position.

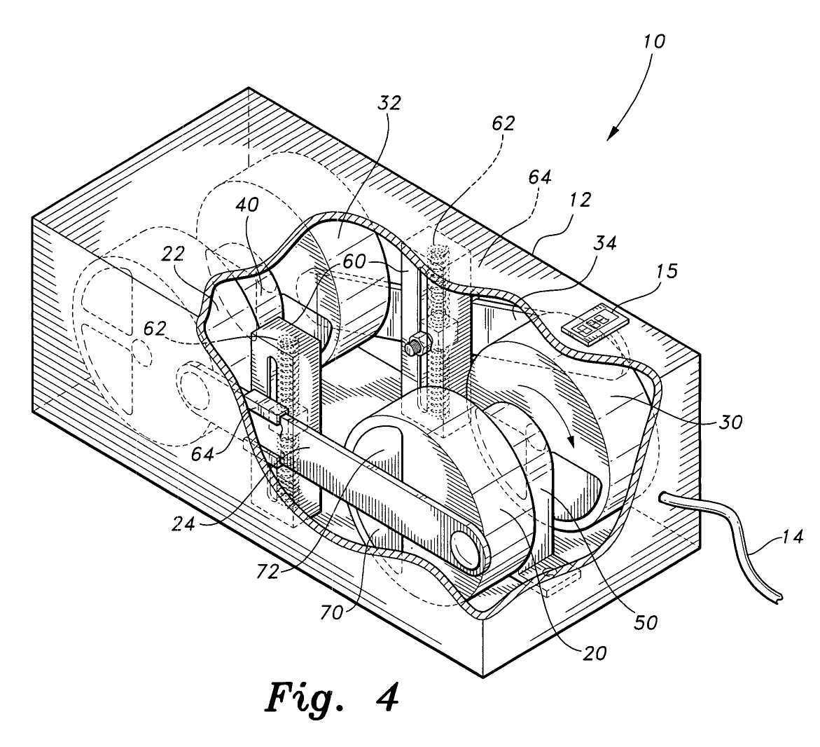

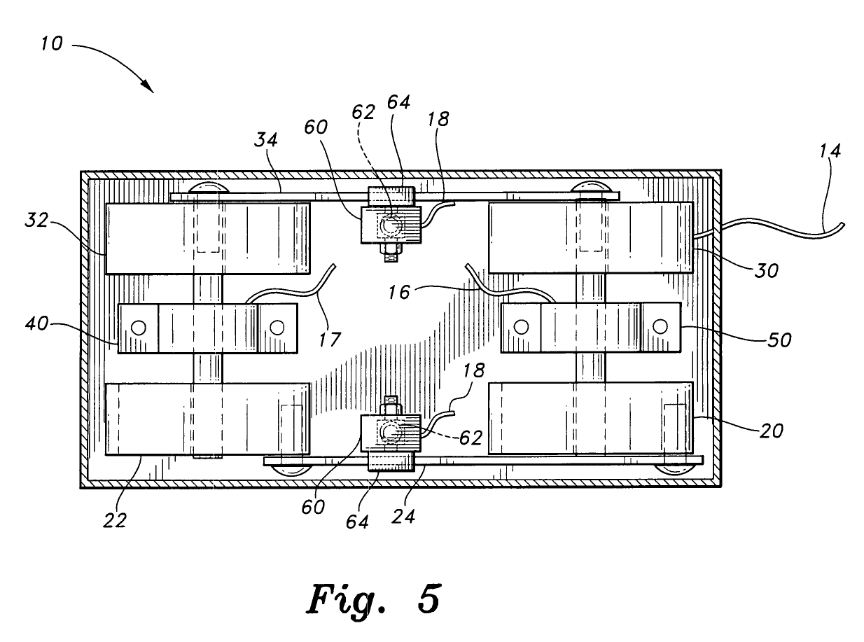

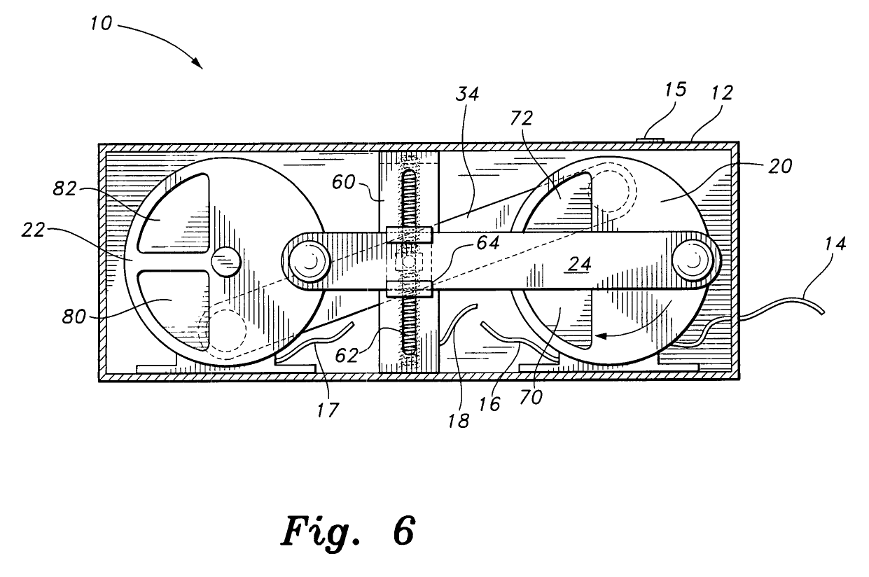

As shown in FIGS. 4-6, an alternative embodiment of the gravity/energy transformer 10 comprises wheels 30 and 32 being rotationally disposed 90° from wheels 20 and 22. In this alternative embodiment, as the two pairs of wheels 20 and 30 rotate on one shaft and the two pairs of wheels 22 and 32 rotate on the other shaft, the position of the bars 24 and 34 move such that when the weights of the wheels 30 and 32 are at their highest position, the interconnecting metal bar 34 has a highest position at its connection point to wheel 30, while having a lowest position at its connection point to wheel 32. At the same time, the two wheels 20 and 22 are rotating and have their interconnecting metal bar 24 at a level that is in-line with a plane defined by the wheel axes of rotation.

Movement of the bars 24 and 34 is monitored by a monitoring arrangement associated with each interconnected pair of wheels 20 and 30, and 22 and 32. The monitoring arrangements each include a metal container 60. Two springs 62 are interconnected to a guide 64 that slidingly engages a corresponding bar 24 or 34. The springs 62 are each biased in a manner to move the guide 64 toward the other interconnected spring 62. As the pairs of wheels 20 and 30, and 22 and 32, rotate on their respective rotational shafts, the positions of the bars 24 and 34 move such that the respective guides 64 to which they are slidingly engaged, cyclically move up and down along slots on either side of the corresponding metal container 60.

Movement of the bars 24 and 34 can be monitored In different ways by a variety of sensor configurations. For example, the bars 24 and 34 can have one or more holes defined therethrough at positions midway between the guide 64. One sensor configuration is a light source and photodiode sensing configuration. The light source or the photodiode can be mounted on a portion of the guide where the springs 62 are interconnected, and other element of this sensing configuration (e.g., the light source or photodiode) can be mounted inside the housing 12 a short interval away from the position of the slot of the housing 60.

When nothing lies between the light source and the photodiode, the photodiode can detect the light source. As a metal bar 24 or 34 moves up and down, passage between the photodiode and the light source breaks detection by the photodiode of the light source. Speed of movement of the metal bar 24 or 34 can be detected by processing the pulsation associated with the bar movement between the light source and the photodiode, and providing a signal via wiring 18. The output AC or DC power being generated by each generator 40 and 50 can then be calculated through use of an equation relating speed of movement of the bar 24 or 34 to AC or DC output power being generated by each generator 40 and 50.

A Hall effect sensor and magnet sensing configuration can also monitor movement of the bars 24 and 34. As with the light and photodiode sensing configuration, the bars 24 and 34 can have one or more holes defined therethrough at positions midway between the guide 64. The Hall effect sensor or the magnet can be mounted within the housing 60 on a portion of the guide where the springs 62 are interconnected, and other element of this sensing configuration (e.g., the Hall effect sensor or magnet) can be mounted inside the housing 12 a short interval away from the position of the slot of the housing 60.

When the hole(s) on the metal bar 24 or 34 are not aligned with the slot on the housing 60 no detection of the metal bar 24 or 34 occurs. When the hole(s) on the metal bar 24 or 34 are aligned with the slot on the housing 60, a reading will be made by the Hall effect sensor and magnet sensing configuration. Speed of movement of the metal bar 24 or 34 can be detected by processing the pulsation associated with the bar movement between the Hall effect sensor and the magnet. The output AC or DC power being generated by each generator 40 and 50 can then be calculated through use of an equation relating speed of movement of the bar 24 or 34 to AC or DC output power being generated by each generator 40 and 50.

As previously described, the generators 40 and 50 can be AC or DC generators. In the generators 40 and 50 the armature conductors are rotated so that they cut the magnetic flux coming from and entering the field poles. In the DC generator the electromagnetic field (emf) induced in the individual conductors is alternating, but this is rectified by the commutator and brushes, so that a unidirectional current flows to the external circuit. The induced emf in a generator is E=øZNP/60P′×10⁸ volts, where ø is the flux entering the armature from one north pole; Z is the total number of conductors on the armature; N is the speed in revolutions per minute (rpm); P is the number of poles; and P′ is the number of parallel paths through the armature.

Since with a given generator, Z, P, and P′ are fixed, then the induced emf is E=KøN volts where K is a constant. When current flows from the armature, the terminal volts V=E−IₐRₐ where Iₐ is the armature current and Rₐ is the armature resistance including the brush and contact resistance which vary somewhat. There are three standard types of DC generators: the shunt generator, the series generator, and the compound generator, any of which can be used with the gravity/energy transformer 10. For AC generators, the armature or stator is the stationary member and the rotating member is ordinarily the filed. There are two general types of field construction, the salient-pole type and the cylindrical or non-salient pole type. Either type of AC generator can be used with the gravity/energy transformer 10.

In summary, the gravity/energy transformer 10 includes a housing 12. First and second rotational shafts are mounted in the housing, each shaft having ends. Generators mounted on each rotational shaft. First and third wheels are mounted proximate the ends of the first shaft on either side of the generator mounted on the first shaft, each wheel having an axis and halves on either side of the axis. Second and fourth wheels are mounted proximate the ends of the second shaft on either side of the generator mounted on the second shaft. A pair of weights is mounted on halves of the first and second wheels and is positioned such that the respective weights are positioned on the same side of their axes. A pair of weights is mounted on halves of the third and fourth wheels such that the respective weights are positioned on the same side of their axes. The weights on halves of the first and second wheels are positioned opposite the weights on halves of the third and fourth wheels so as to rotationally counteract one another.

The gravity/energy transformer 10 also includes a metal bar rotationally attached proximate a circumference of the first and second wheels on the half of the wheel opposite the half of the associated wheel where the weights are mounted, and a metal bar rotationally attached proximate a circumference of the third and fourth wheels on the half of the wheel opposite the half of the associated wheel where the weights are mounted.

The gravity/energy transformer 10 has a power output cord connected to the housing. The gravity/energy transformer has a display on the housing to provide an analog and/or digital indication of an amount of AC and/or DC electrical output power being developed by the gravity/energy transformer. The display can be a dial indicator, an LCD, an organic LCD display, an LED display, an OLED display, or a thin film transistor display. The display can be a touch sensitive screen. The gravity/energy transformer 10 has a monitoring arrangement positioned between the first and second shafts.

The monitoring arrangement includes a metal housing with two opposing sides and a longitudinal slot extending along each of the two opposing sides. A guide is configured to slidingly engage one of the bars, and a pair of springs is attached to the guide, each one of the pair of springs being biased in a manner to move the guide toward the other spring of the pair of springs. The monitoring arrangement can have a light source and photodiode sensing configuration or a Hall effect sensor and magnet sensing configuration. The generators can be AC generators or DC generators. DC generators can be shunt generators, series generators, or compound generators.

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

It is to be understood that the present invention is not limited to the embodiment described above, but encompasses any and all embodiments within the scope of the following claims.

I claim:

1. A gravity/energy transformer comprising:
a housing;
first and second rotational shafts, each of the shafts having ends;
generators mounted on each of the rotational shafts;
first and third wheels mounted proximate the ends of the first shaft on either side of the generator mounted on the first shaft, each wheel having an axis and halves on either side of the axis;
second and fourth wheels mounted proximate the ends of the second shaft on either side of the generator mounted on the second shaft;
a pair of weights mounted on halves of the first and second wheels and positioned so that their respective weights are positioned on the same side of the axes; and
a pair of weights mounted on halves of the third and fourth wheels so that their respective weights are positioned on the same side of the axes,
wherein the weights on halves of the first and second wheels are positioned opposite the weights on halves of the third and fourth wheels in order to rotationally counteract one another, thereby causing rotation of the wheels to turn the generators until frictional forces cause the wheels to stop rotating.

2. The gravity/energy transformer according to claim 1, further comprising
a metal bar rotationally attached proximate a circumference of the first and second wheels on the half of the wheel opposite the half of the associated wheel where the weights are mounted; and
a metal bar rotationally attached proximate a circumference of the third and fourth wheels on the half of the wheel opposite the half of the associated wheel where the weights are mounted.

3. The gravity/energy transformer according to claim 1, further comprising a power output cord connected to the housing.

4. The gravity/energy transformer according to claim 1, further comprising a display on the housing to provide an analog and/or digital indication of an amount of AC and/or DC electrical output power being developed by the gravity/energy transformer.

5. The gravity/energy transformer according to claim 4, wherein said display is a dial indicator.

6. The gravity/energy transformer according to claim 4, wherein said display is selected from the group consisting of a liquid crystal display (LCD), an organic LCD display, a light emitting diode (LED) display, an OLED display, and a thin film transistor display.

7. The gravity/energy transformer according to claim 6, wherein said display has a touch sensitive screen.

8. The gravity/energy transformer according to claim 2, further comprising a monitoring arrangement associated with each of the first and second shafts.

9. The gravity/energy transformer according to claim 8, wherein said monitoring arrangement comprises:
a metal housing with two opposing sides and a longitudinal slot extending along each of the two opposing sides;
a guide configured to slidingly engage one of the bars; and
a pair of springs interconnected to the guide, each one of the pair of springs being biased in a manner to move the guide toward the other spring of the pair of springs.

10. The gravity/energy transformer according to claim 1, wherein said monitoring arrangement further comprises a light source and photodiode sensing configuration.

11. The gravity/energy transformer according to claim 1, wherein said monitoring arrangement further comprises a Hall effect sensor and magnet sensing configuration.

12. The gravity/energy transformer according to claim 1, wherein said generators are AC generators.

13. The gravity/energy transformer according to claim 1, wherein said generators are DC generators.

14. The gravity/energy transformer according to claim 1, wherein said DC generators are selected from the group consisting of shunt generators, series generators, and compound generators.

15. A gravity/energy transformer comprising:
a housing;
first and second rotational shafts, each of the shafts having ends;
generators mounted on each rotational shaft;
first and third wheels mounted proximate the ends of the first shaft on either side of the generator mounted on the first shaft, each of the wheels having an axis and halves on either side of the axis;
second and fourth wheels mounted proximate the ends of the second shaft on either side of the generator mounted on the second shaft;
a pair of weights mounted on halves of the first and second wheels and positioned so that their respective weights are positioned on the same side of the axes;
a pair of weights mounted on halves of the third and fourth wheels so that their respective weights are positioned on the same side of the axes, the weights on halves of the third and fourth wheels being rotationally disposed ninety degrees from the weights on halves of the first and second wheels;
a first interconnecting bar proximate to respective circumferential edges of first and second wheels, the first and second wheels being rotationally attached to opposing ends of the first interconnecting bar; and
a second interconnecting bar proximate to respective circumferential edges of third and fourth wheels, the third and fourth wheels being rotationally attached to opposing ends of the second interconnecting bar;
wherein the first and second wheels rotationally counteract the third and fourth wheels, thereby causing rotation of the wheels to turn the generators until frictional forces cause the wheels to stop rotating.

16. The gravity/energy transformer according to claim 15, further comprising a power output cord connected to the generators.

17. The gravity/energy transformer according to claim 15, further comprising a display on the housing to provide an indication of an amount of electrical output power being developed by the gravity/energy transformer.

18. The gravity/energy transformer according to claim 15, wherein when the weights of the third and fourth wheels are at their highest position, the interconnecting metal bar has a highest position at its connection point to the third wheel, while having a lowest position at its connection point to the fourth wheel at the same time the first and second wheels are rotating and have their interconnecting metal bar at a level that is in-line with a plane defined by the wheel axes of rotation.
